(19) United States
(12) Patent Application Publication
(10) Pub. No.: US 2011/0239871 A1
(43) Pub. Date: Oct. 6, 2011

(54) TOASTER WITH FUNCTIONS OF BAKING BREADS AND COOKING FOODS

(76) Inventor: CHENG-CHANG LIN, Taoyuan (TW)

(21) Appl. No.: 12/753,900

(22) Filed: Apr. 4, 2010

(51) Int. Cl. A47J 37/08

(52) U.S. Cl. 99/385; 219/443.1

(57) ABSTRACT

A toaster with functions of baking breads and cooking foods comprises a body having at least one receiving space. There are two heating plates, one left heating plate and one right heating plate; the left heating plate and the right heating plate are installed at a left and a right side of the body, respectively; an inner side of each of the left heating plate and right heating plate is formed with a cooking area for cooking. A lower end of each of the left heating plate and right heating plate is formed with a penetrating hole. A shaft passes through the penetrating hole. Two ends of the shaft are installed to the body so that the right heating plate and the left heating plate can rotate along the shaft to be opened or closed.

### FIELD OF THE INVENTION

The present invention is related to toasters, and particularly to a toaster with functions of baking breads and cooking foods.

### BACKGROUND OF THE INVENTION

In U.S. Pat. No. 7,335,858, a toaster is provided, which uses radiant heat at infrared wavelengths optimized for producing rapid and uniform toasting of a food product. The infrared wavelengths of the radiated heat are selected for optimum speed and quality (browning and moisture content) of the food product. The selected infrared wavelengths of the radiated heat may also effectively defrost a food product. Defrosting of the food product by the infrared radiated heat adds very little time in obtaining a desired toast color to the food product. A plurality of infrared wavelengths of radiated heat may also be used, wherein the plurality of infrared wavelengths are selected for optimal heat penetration and surface browning of the food product. Shorter wavelengths for browning and slightly longer wavelengths to penetrate the food product for evaporating the moisture therein to allow surface browning by the shorter wavelengths. In addition, the heating energy within the toaster may be further elongated (longer wavelengths) once the infrared radiation is re-radiated off of reflectors within the toaster. The wavelengths of infrared radiated heat may be from about 1 to about 3 microns, and preferably from about 1.96 to about 2.5 microns, and most preferably at about 2.11 microns.

In U.S. Pat. No. 7,290,482, a toaster system is provided, in that, a selectively removable imaging plates is provided. The system includes a toaster having at least one toast receiving compartment with heating elements disposed along both sides thereof for facing the food item to be toasted. The system also includes a plurality of metal imaging plates, each individually and selectively receivable in and removable from the toast receiving compartment at a location between one of the heating elements and the inserted food item that is to be toasted.

However, above mentioned toaster only changes the structures of the original one, but still have only one function of baking breads. Other extra function is provided. For singles living in a small room without kitchen, even if it is ruled that no cooking in the room, as a result, the user must prepare two different kinds of electric cooking devices, such as a toaster and an electric pot for baking breads and cooking foods. It is troublesome and space-inefficient. Therefore, it is necessary for a novel design which can resolve above problem by providing only one machine having both the functions of baking and cooking.

### SUMMARY OF THE INVENTION

Therefore, the object of the present invention is to provide the above mentioned prior art problem, the present invention provides a toaster with the function of frying and cooking. Other than baking breads, it also provides the function of frying and cooking. No extra pot or pan is needed. This is especially suitable for singles living in a small space without kitchens. The space for cooking is reduced to only a small one.

To achieve above object, the present invention provides a toaster with functions of baking breads and cooking foods, comprising: a body having a receiving space; an upper side of the receiving space having a bread receiving opening; and at least one heating plate at one side of the toaster. A heating unit formed by a plurality of resistors and installed in the receiving space; the heating unit is connected to the control button. It may be that there are two heating plates, one left heating plate and one right heating plate; the left heating plate and the right heating plate are installed at a left and a right side of the body, respectively; an inner side of each of the left heating plate and right heating plate is formed with a cooking area for cooking. A lower end of each of the left heating plate and right heating plate is formed with a penetrating hole. A shaft passes through the penetrating hole. Two ends of the shaft are installed to the body so that the right heating plate and the left heating plate can rotate along the shaft to be opened or closed. In open operation, the left heating plate or right heating plate rotate along the shaft so that the left heating plate or the right heating plate is almost vertical to the surfaces of the body; therefore, the user can cook foods on the left heating plate and right heating plate.

The various objects and advantages of the present invention will be more readily understood from the following detailed description when read in conjunction with the appended drawing.

### BRIEF DESCRIPTION OF THE DRAWING

FIG. 1 is an exploded perspective view of the present invention.

FIG. 2 is a perspective view of the present invention.

FIG. 3 shows one application of the present invention.

FIG. 4 shows another application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

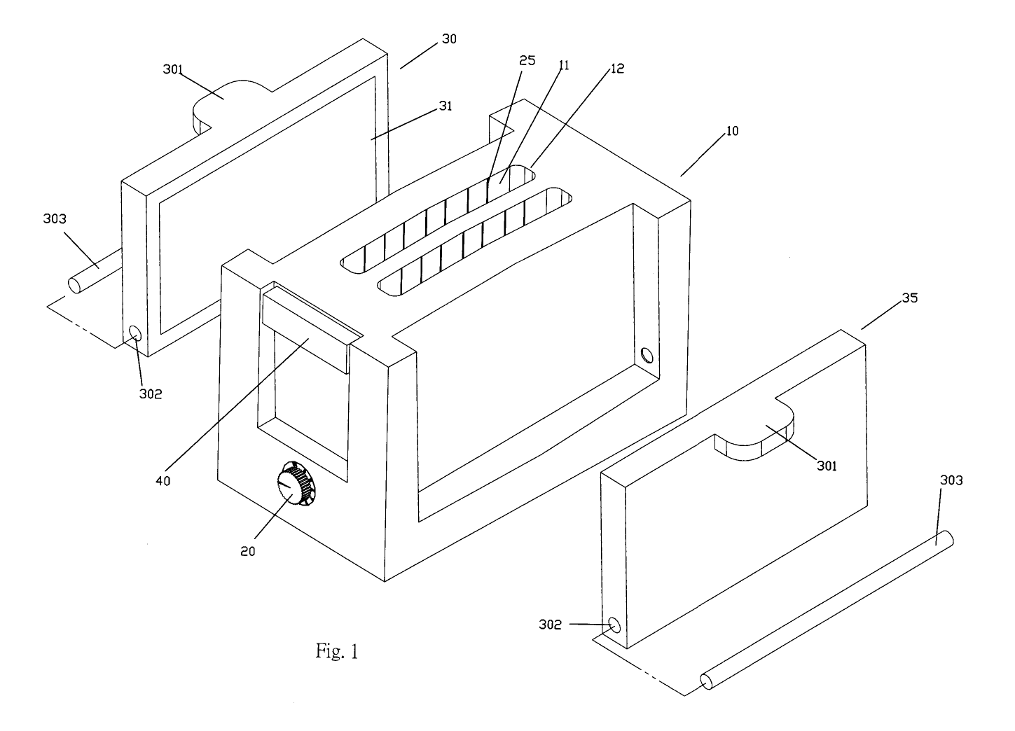

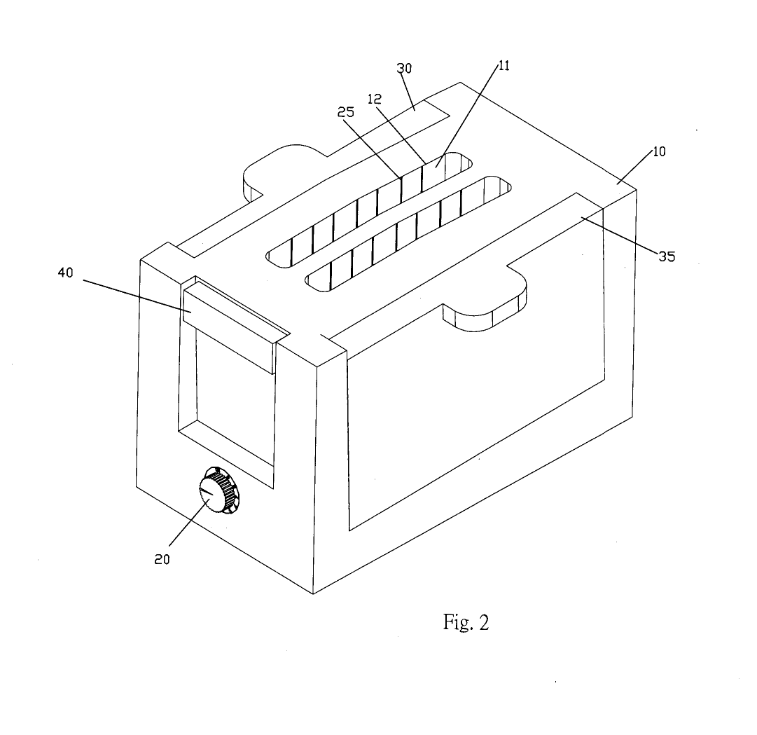

With referring to FIGS. 1 to 4, the toaster with the function of baking breads and cooking foods of the present invention is illustrated. The present invention includes the following elements.

A body 10 is made of heat-tolerant material and includes at least one receiving space 11. An upper end of the receiving space 11 has a bread receiving opening 12 (referring to FIG. 1). In this embodiment, two receiving spaces 11 are illustrated.

Control buttons 20 serve for setting the cooking time and temperature for cooking the breads.

A heating unit 25 is made of a plurality of resistors and is placed in the receiving space 11. The heating unit 25 is connected to the control buttons 20.

A left heating plate 30 and a right heating plate 35 are installed at a left and a right side of the body 10, respectively. An outer top end of each of the left heating plate 30 and the right heating plate 35 is installed with a holding portion 301. An inner side of each of the left heating plate 30 and right heating plate 35 is formed with a cooking area 31 for cooking.

A lower end of each of the left heating plate 30 and right heating plate 35 is formed with a penetrating hole 302. A shaft 303 passes through the penetrating hole 302. Two ends of the shaft 303 are installed to the body 10 so that the right heating plate 35 and the left heating plate 30 can rotate along the shaft 303 to be opened or closed.

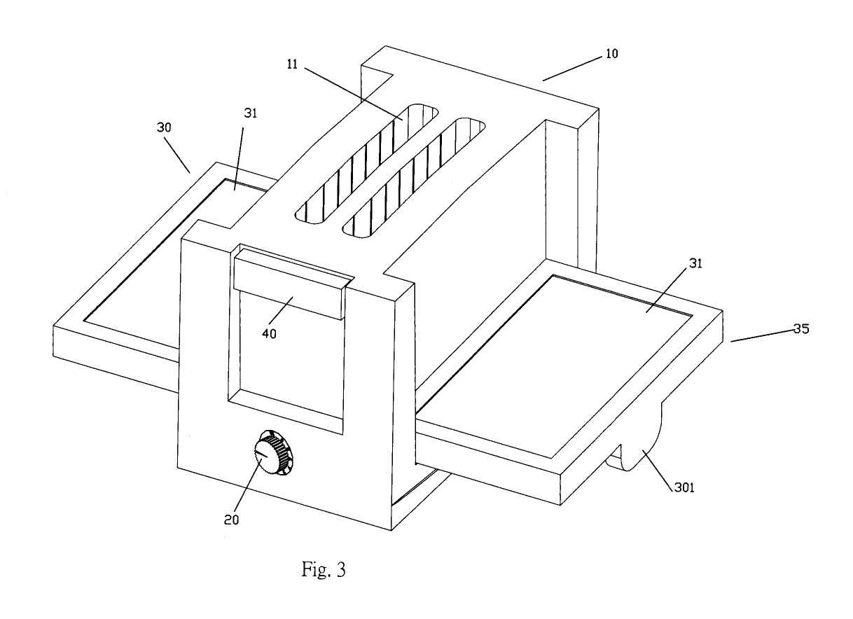

In opening operation, the left heating plate 30 and right heating plate 35 rotate along the shaft 303 so that the left heating plate 30 and the right heating plate 35 are almost vertical to the surfaces of the body 10. Therefore, the user can cook foods on the left heating plate 30 and right heating plate 35, such as decoct, etc. The left heating plate 30 and the right heating plate 35 are electrically heated, for example to embed resistor wires therein for heating (referring to FIG. 3).

One side of the body 10 has a bread in/out mechanism 40 for placing breads into the receiving space 11. When the mechanism 40 is pressed downward, it will descend to the receiving space 11. Meanwhile, the heating unit is actuated for baking the bread. After a predetermined time, the bread will be ejected from the receiving space 11 automatically.

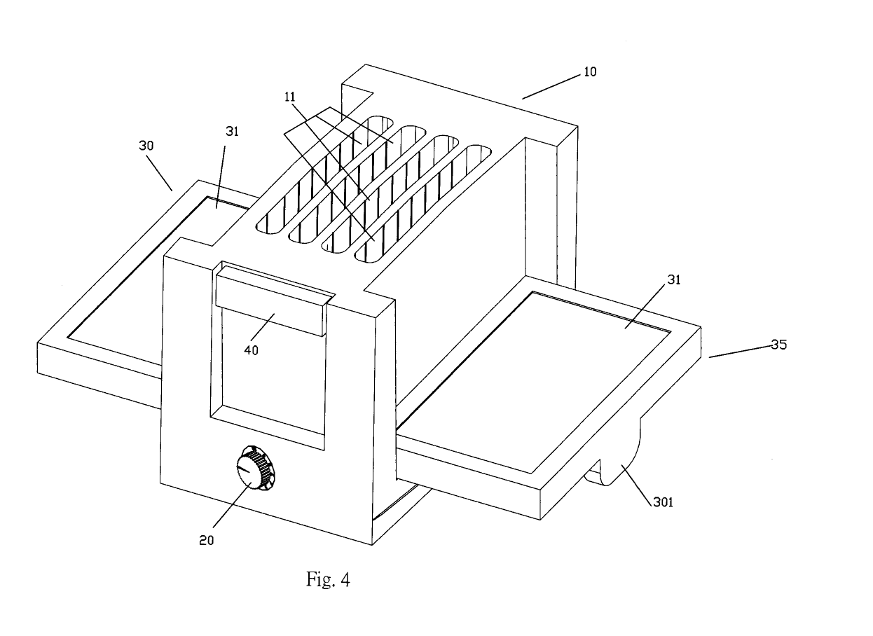

FIG. 4 shows an example where four receiving spaces are used. The structure is like the above mentioned.

Preferably, the left heating plate and right heating plate are enclosed by casing, respectively so as not to harm the user's hand or burn the table supporting the toaster.

Advantages of the present invention are that other than baking breads, the toaster also provides the function of frying and cooking. No other pot or pan is necessary. This is especially suitable for singles. Only one machine is prepared. No kitchen is needed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A toaster with functions of baking breads and cooking foods, comprising:
a body having a receiving space; an upper side of the receiving space having a bread receiving opening; and
at least one heating plate at one side of the toaster.

2. A toaster with functions of baking breads and cooking foods as claimed in claim 1, further comprising:
a control button for setting time and temperature of baking and cooking.

3. The toaster with functions of baking breads and cooking foods as claimed in claim 1, further comprising:
a heating unit formed by a plurality of resistors and installed in the receiving space; the heating unit is connected to the control button.

4. The toaster with functions of baking breads and cooking foods as claimed in claim 1, wherein there are two heating plates, one left heating plate and one right heating plate; the left heating plate and the right heating plate are installed at a left and a right side of the body, respectively; an inner side of each of the left heating plate and right heating plate is formed with a cooking area for cooking.

5. The toaster with functions of baking breads and cooking foods as claimed in claim 1, wherein a lower end of each of the left heating plate and right heating plate is formed with a penetrating hole; a shaft passes through the penetrating hole; two ends of the shaft are installed to the body so that the right heating plate and the left heating plate can rotate along the shaft to be opened or closed;
wherein in opening operation, the left heating plate or right heating plate rotate along the shaft so that the left heating plate or the right heating plate is almost vertical to the surfaces of the body; therefore, the user can cook foods on the left heating plate and right heating plate.

6. The toaster with functions of baking breads and cooking foods as claimed in claim 1, wherein one side of the body has a bread in/out mechanism for placing breads into the receiving space; when the mechanism is pressed downward, it will descend to the receiving space; meanwhile, the heating unit is actuated for baking the bread; after a predetermined time, the bread will be ejected from the receiving space automatically.

7. The toaster with functions of baking breads and cooking foods as claimed in claim 1, wherein an outer top end of each of the left heating plate and the right heating plate are installed with a holding portion.

8. The toaster with functions of baking breads and cooking foods as claimed in claim 1, wherein there are two receiving spaces.

9. The toaster with functions of baking breads and cooking foods as claimed in claim 1, wherein there are four receiving spaces.

10. The toaster with functions of baking breads and cooking foods as claimed in claim 1, wherein the left heating plate and right heating plate are electrically heated.

11. The toaster with functions of baking breads and cooking foods as claimed in claim 1, wherein the left heating plate and right heating plate are enclosed by casing, respectively so as not to harm the user's hand or burn the table supporting the toaster.
